(19) United States
(12) Patent Application Publication
(10) Pub. No.: US 2013/0322075 A1
(43) Pub. Date: Dec. 5, 2013

(54) OPTICAL COMPONENT AND ASSOCIATED ILLUMINATING DEVICE

(71) Applicant: Stefan Hadrath, Falkensee (DE)

(72) Inventor: Stefan Hadrath, Falkensee (DE)

(73) Assignee: OSRAM GMBH, Muenchen (DE)

(21) Appl. No.: 13/984,294

(22) PCT Filed: Feb. 11, 2011
(86) PCT No.: PCT/EP11/52010

§ 371 Date: Aug. 8, 2013

(51) Int. Cl. F21V 5/04

(52) U.S. Cl. CPC F21V 5/045; F21V 5/04
USPC 362/235; 362/335

(57) ABSTRACT

An optical component having a carrier plate or substrate, which includes a first main surface and a second main surface facing away from the first main surface, having a given lens structure in the form of a microlens array on the first main surface, wherein the first lens structure covers the first main surface, and having a lens structure in the form of a microlens array on the second main surface, wherein the lens structure of the second main surface is similar to that of the first in the meaning of a projection, wherein the projection is distorted by a factor a in relation to an origin, which is located at an arbitrary point of the main surfaces, wherein the distortion factor a is at least a=1,001, wherein the distortion is active in at least one direction is disclosed.

### RELATED APPLICATIONS

The present application is a national stage entry according to 35 U.S.C. §371 of PCT application No. PCT/EP2011/052010 filed on Feb. 11, 2011.

### TECHNICAL FIELD

Various embodiments relate to an optical component. It is intended in particular for illuminating devices such as modules or lamps or lights. Furthermore, various embodiments relate to an illuminating device having such a component.

### BACKGROUND

US 2004/008411 describes a microlens array for optical purposes. The optical structure is attached to one of the two main surfaces of the microlens array.

WO 2009/065389 discloses an optical component having two surfaces, to each of which a lens structure is applied. The second lens structure corresponds to the first lens structure, except that it is applied mirror-inverted to the second surface. In WO 02/10804, the second lens structure is embodied completely differently from the first lens structure.

### SUMMARY

Various embodiments provide an improved optical component, which is suitable for homogenizing the luminance distribution in an illuminating device.

Various embodiments further provide an illuminating device which displays a homogenized luminance distribution.

Fundamentally, various embodiments relate to an optimized optical component and an associated illuminating device. The illuminating device is used for color mixing of different-colored light sources, in particular chips or LEDs (light-emitting diodes) or modules thereof.

The attempt is made to provide an optical component for color mixing of different-colored semiconductor components, such as LEDs. The result is a homogenization of the luminance distribution of an illuminating device equipped therewith having a blurred, not sharply delimited transition between illuminated and non-illuminated surface. The optical component uses the technology of microlens arrays, also referred to as MLA in short, or fly's eyes.

Such MLAs are used particularly readily in novel LED lamps, in particular also in retrofit lamps, in order to mix the spectra of different-colored light sources, typically LEDs or also laser diodes, and to homogenize the luminance distribution.

The fundamental problem is that a good color reproduction can only be achieved by color mixing of a plurality of different-colored LEDs. The art is to achieve good color mixing with high optical efficiency at the same time.

For bright LED lamps which consist of a plurality of LEDs, inter alia, fundamentally either white or different-colored LEDs are used. The white LEDs consist of blue LEDs, to which a phosphor layer is connected upstream for the partial conversion into yellow or also green and red secondary radiation. However, only relatively low values of the color reproduction may be achieved using this technology.

If different-colored LEDs are used for a white light source, substantially better color reproduction is fundamentally possible, however, this technology results in undesired color shadows in the near field. In addition, undesired color shadows occur if objects or persons move into the line of sight. For good color mixing, double-sided MLAs are frequently used for this purpose, as described in WO 2009/065389.

FIGS. 1A to 1C show an illustration of this known prior art. Both sides having the main surfaces of the lens structure have a mirror-symmetrical arrangement to one another. This means that each surface having a lenslet is opposite to an exactly identical surface on the second side. The lens structure itself, i.e., the shape of the individual lenslets, is not fixed. It can be rectangular, hexagonal, circular, or also honeycomb-shaped, as described in detail in WO 2009/065389.

In such an arrangement, however, the transition between illuminated and non-illuminated area of a lighting device having such an optical component is quite sharp. This sharp light-dark boundary is often not at all desired by the users for aesthetic reasons.

A known solution approach is a randomized MLA, for example, as disclosed in US 2004/008411. However, this solution has the fundamental disadvantage that the danger exists that an illumination structure having wings at the corners will result, which only disappears by way of a linear arrangement of as many LEDs as possible having separate reflector.

The solution proposed here is to design the second lens structure on the second main surface to be intentionally similar to the lens structure on the first main surface. The guideline for the alteration is to use a geometric distortion of the lens structure of the first main surface for the second main surface. Therefore, the size and the distance of the adjoining lenslets are different than on the first main surface in the meaning of a distorted projection. This distortion can have a plurality of axes of symmetry having a differing distortion factor a, b, c, . . . with respect to the individual axis of symmetry.

An arrangement is preferred in which the distortion is equal in every spatial direction, originating from the center point of the optical component. The distortion factor a is preferably in a range of the distortion of at most up to 5%, i.e., a=1.05. A range from 1.001≦a≦1.01 is advantageous. It is sufficient for the values to differ only slightly from one another.

A further advantageous embodiment is a distortion in two axes, which are preferably perpendicular to one another. They are understood hereafter as the x axis and y axis. For the distortion factor in the x direction, defined as ax, a similar advantageous value range applies: 1.001≦ax≦1.05.

In a similar way, use is made of a distortion factor ay in the y direction, a similar advantageous value range also applies here: 1.001≦ay≦1.05.

In particular, ax=ay is frequently selected. However, ax can also be different from ay, wherein the larger value of the two is particularly not to differ by more than 30% from the smaller value. A maximum distortion factor of 1% is typically already sufficient.

A concrete example is the use of a trapezoidal, honeycomb-shaped, rhomboid, or rectangular lenslet having a distortion factor a of 0.3 to 1%, i.e., 1.003≦a≦1.01.

Fundamentally, the front or the rear MLA can be enlarged with a>1, relative to the respective other one. The larger MLA is preferably on the light exit side.

Fundamentally, the origin of the projection can be fixed at an arbitrary point of the main surfaces. However, it is preferably located in the center point of the carrier, given by the origin U, or at least in a region which is at most 20% of the distance D from the center point Z of the carrier to the edge of the main surface. In the case of an asymmetrical design of the main surface, this displacement value V relates to the greatest distance D between origin and edge of the main surface.

The lens structure normally completely covers the main surface, however, this is not indispensable.
An optical component having a carrier plate or substrate, which comprises a first main surface and a second main surface facing away from the first main surface, having a given lens structure on the first main surface, wherein the first lens structure covers the first main surface, and having a lens structure on the second main surface, wherein the lens structure of the second main surface is similar to that of the first, wherein the projection is distorted by a factor a is disclosed.
In a further embodiment, the optical component is configured such that the distortion is identical in all directions of the main surface.
In a still further embodiment, the distortion has axes of symmetry.
In a still further embodiment, the distortion has two to five axes of symmetry and in particular has two axes of symmetry perpendicular to one another.
In a still further embodiment, the distortion factor a is at least 1.001 and preferably at most 1.05.
In a still further embodiment, the distortion factor a is at most 1%.
In a still further embodiment, the distortion factor differs in various directions by at most 30%.
In a still further embodiment, the distortion factor is of equal size in both directions.
In a still further embodiment, the distortion factor changes as a function of the distance from the origin. For example, it can increase linearly or quadratically.
In a still further embodiment, the lens structure has a polygonal shape, in particular a triangle, rectangle, rhomboid, trapezoid, or honeycomb, wherein in particular complete paving of the main surface is achieved.
In a still further embodiment, the lens structure comprises multiple different-shaped lens elements.
An illuminating device having at least two different-colored light sources and having an optical component is disclosed.
An illuminating device having an optical component is disclosed. The device also includes: the light sources emit light in a limited spatial angle in operation, wherein the optical component as claimed in any one of claims 1 to 10 is seated in the beam path of the light sources, and wherein the light sources have an arrangement having light-emitting semiconductor components and a collimator arranged downstream from the arrangement.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIGS. 1A to 1C show an optical component as a schematic illustration;

FIGS. 2A and 2B an optical component according to the disclosure in various views;

FIG. 3 shows a further exemplary embodiment of an optical component;

FIG. 4 shows the distribution of the illuminance of an optical component according to the prior art;

FIG. 5 shows a schematic illustration of a lenslet according to the disclosure;

FIGS. 6A and 6B show an illustration of the difference of both sides of an optical component according to the disclosure and a detail view (FIG. 6B) thereof;

FIG. 7 shows the distribution of the illuminance of an optical component according to the disclosure.

### DETAILED DESCRIPTION

Identical or identically acting components may each be provided with identical reference signs in the embodiments and figures.

The illustrated elements and the size ratios thereof to one another are fundamentally not to be considered to be to scale, rather individual elements, for example, layers, parts, components, and regions, may be shown exaggeratedly thick or dimensioned large for better representation and/or for better understanding.

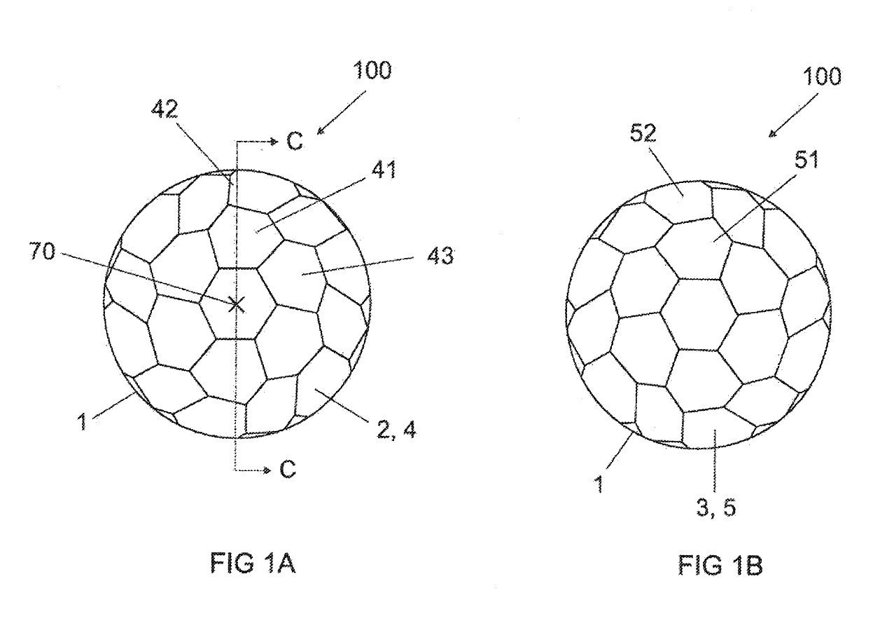

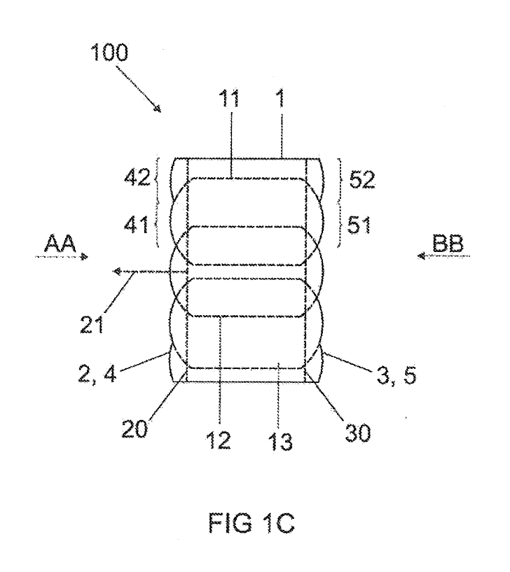

FIGS. 1A to 1C show an exemplary embodiment of an optical component 100. The illustration of FIG. 1C shows a section through the optical component 100 along the sectional plane CC shown in 1A. FIG. 1A shows a front view of the optical component from the direction AA identified in 1C, while FIG. 1B shows a rear view from the direction BB identified in 1C. The following description refers equally to FIGS. 1A to 1C.

FIGS. 1A to 1C schematically show an exemplary embodiment of an optical component 1, which comprises a carrier plate or substrate 2. It is manufactured from optically transmissive material such as plastic or glass. The substrate 2 has a circular shape having a radius D here. Alternatively thereto, of course, the substrate may also have a different design, which displays less symmetry, in particular a polygonal or elliptical shape or a combination of the two.

The carrier plate is preferably integrally produced by means of a molding process together with the first and second lens structures 3, 4 described hereafter.

The optical component 100 includes a carrier plate 1 made of an optical material, preferably plastic, which has a circular shape. Alternatively thereto, the carrier plate 1 can also have a polygonal or elliptical shape or a combination thereof.

The carrier plate 1 has a first main surface 2 having a first lens structure 4 and a second main surface 3, facing away from the first main surface 2, having a second lens structure 5. The first main surface 2 is formed by the first lens structure 4, which completely covers the first main surface 2, while the second main surface is formed by the second lens structure 5, so that the second lens structure 5 completely covers the second main surface 3. The first main surface 2 also has a main extension direction 20, while the second main surface 3 has a main extension direction 30 parallel thereto. A surface normal 21 as shown in 1C is defined by the main extension directions 20 and 30.

The first lens structure 4 has a plurality of lens elements, of which a first lens element 41, a second lens element 42, and a further lens element 43 are designated as examples. The number of the lens elements shown is solely exemplary and is not restrictive. As an alternative to the embodiment shown, the carrier plate for example can also only have the first and the second lens elements 41, 42 as the lens structure 4.

The first and the second lens element 41, 42 have, like all further lens elements of the first lens structure 4, a polygonal shape. In particular, the first lens element 41 has a first polygonal shape, while the second lens element 42 has a second polygonal shape. They preferably have the same shape.

In one embodiment, the first and the second polygonal shapes are not congruent, since, for example, the first polygonal shape of the first lens element 41 cannot be converted into the second polygonal shape by a rotation around an axis of rotation parallel to the surface normal 21 or by a translation. The polygonal shape of all lens elements which do not directly border the edge region of the first main surface 2 is hexagonal. Complete and continuous coverage or paving of the first main surface 2 using the first lens structure 4 is thus possible. Another preferred embodiment of the lens elements or lenslets is rectangular.

In contrast thereto, for example, the first lens element 41 and the further lens element 43 differ by their orientation on the first main surface 2 of the carrier plate 1. The first lens element 41 and the further lens element 43 are congruent, but are pivoted relative to one another about an axis of rotation parallel to the surface normal 21 and are arranged translated on the carrier plate 1.

Furthermore, the lens elements of the first lens structure 4 could have a vortex structure, but this is not absolutely necessary. This means that the lens elements are rotated more and more about an axis of rotation parallel to the surface normal 21 as the distance to a center point 70 of the first main surface becomes greater. Therefore, each lens element of the lens structure 4 is pivoted in relation to its directly adjacent lens elements in the radial direction. In addition to the non-congruent formation of the lens elements, this rotation contributes still further to the destruction of a possible symmetry of the lens elements.

However, a lens structure of high symmetry can advantageously be selected.

Furthermore, each of the lens elements has an area which it occupies on the main surface 2 and which becomes smaller with increasing distance from the center point 70. Effects thus result on the emission characteristic of the optical component, which will be explained in greater detail in conjunction with 3.

In addition, the optical element 1 has a second lens structure 5 on the second main surface 3, which is fundamentally mirror-inverted or congruent to the first lens structure 4. This means that the second lens structure is in principle respectively embodied as mirror-inverted in comparison to the first lens structure and has lens elements arranged mirror-inverted, as shown solely as an example on the basis of the first lens element 51 and the second lens element 52 of the second lens structure 5, which correspond to the first and second lens elements 41, 42 of the first lens structure 4, respectively.

However, the decisive difference is that the second lens structure represents a distorted projection of the first lens structure. Without restriction of the generality, the center of the MLA may be located in the origin of the coordinate system, in relation to the distortion. The two lens structures on the two main surfaces are not exactly identical, but rather the distances of the individual lenslets are greater on the second side, which is arbitrarily defined, i.e., the second main surface, than on the first side.

The center points of the individual lenslets on the first side are defined by the distances dx1 in the x direction and dy1 in the y direction. The center points of the individual lenslets on the opposite second side are, in contrast, defined by the distances dx2 and dy2 in the x direction or y direction, respectively. In this case, dx2=a*dx1 and dy2=b*dy1. Typical values are b=1.0*a to b=1.3*a. A typical value for a is 1.001≦a≦1.01. A very low distortion factor is thus already sufficient to advantageously be able to use a lens structure of high symmetry, so that the design of such main surfaces is made significantly easier.

Accordingly, the lenslet “i” has on the first side the position of its center point at (x_i/y_i) and has on the second side the position of its center point at (a*x_i/b*y_i).

The lenslets themselves are lens sections which are fundamentally identical on both sides, in particular spherical or aspherical lenses.

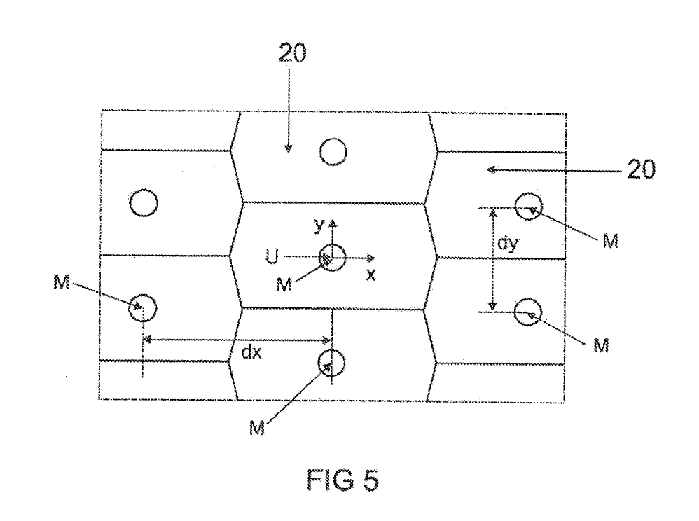

This lenslet 20 is shown as an example for a hexagonal arrangement in FIG. 5.

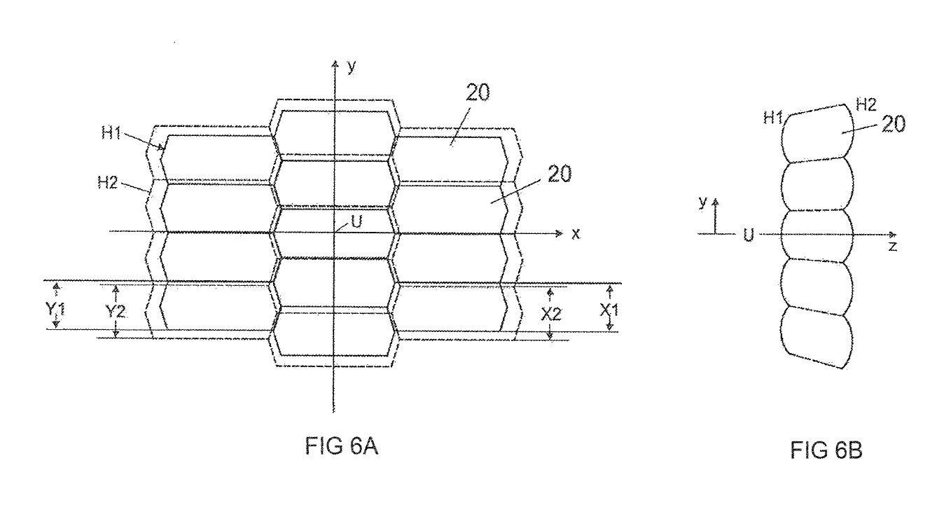

In FIG. 6A, the lenslets 20 of one side are shown by solid lines (surface H1) and the lenslets of the second side are shown by dashed lines (surface H2). This principle is applicable to circular, rectangular, and other structures. FIG. 6B shows a detail in a side view thereof.

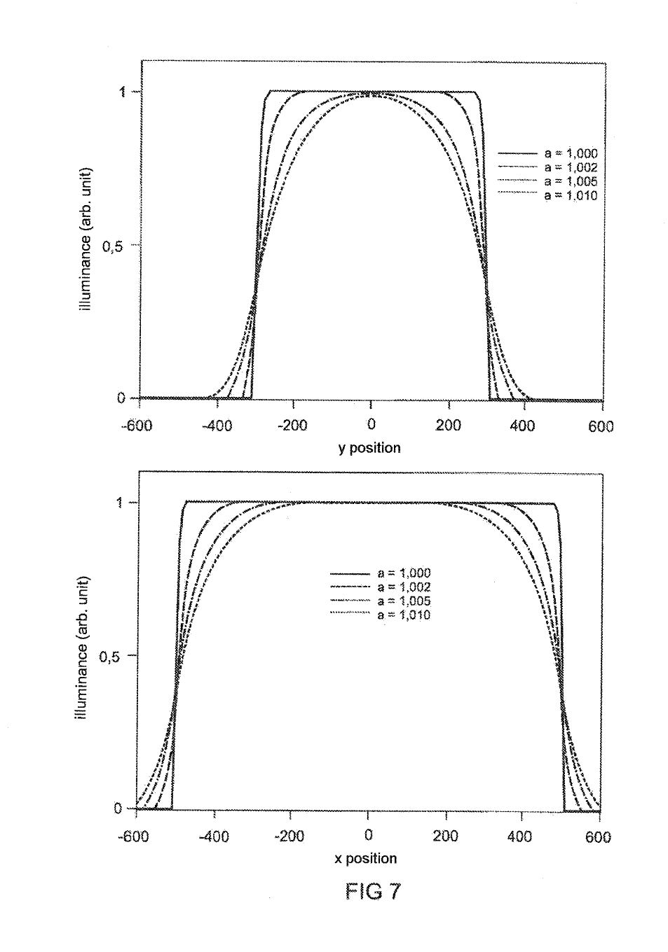

FIG. 7 shows an example of the illuminance distribution and sections in the x and y directions for four different values of a, designated with row 1 to row 4.

This guideline on the construction of an optical component does not have an influence on the light mixing itself.

The shape or arrangement of the lenslets determines the shape of the illuminated area. I.e., in the case of hexagonal arrangement, as in the example shown here, a hexagon is on the wall in the far field.

Alternatively to the arrangement of the lens elements shown in 1A to 1C, these can also all differ from one another in pairs, i.e., can be non-congruent.

As is obvious from FIG. 1C, each lens element has a curved surface on each of the two main surfaces 2 and 3 of the carrier body 1. In general, all lens elements have surfaces having the same curvature and therefore the same focal length. In the exemplary embodiment shown, the lens elements correspond to parts of biconvex lenses, wherein in 1C, the fundamental imaginary biconvex lenses 11, 12, 13 are indicated as examples by the dashed lines in the carrier body 1. The carrier body 1 and the first and second lens structures 4, 5 can therefore approximately be understood as overlapping lenses.

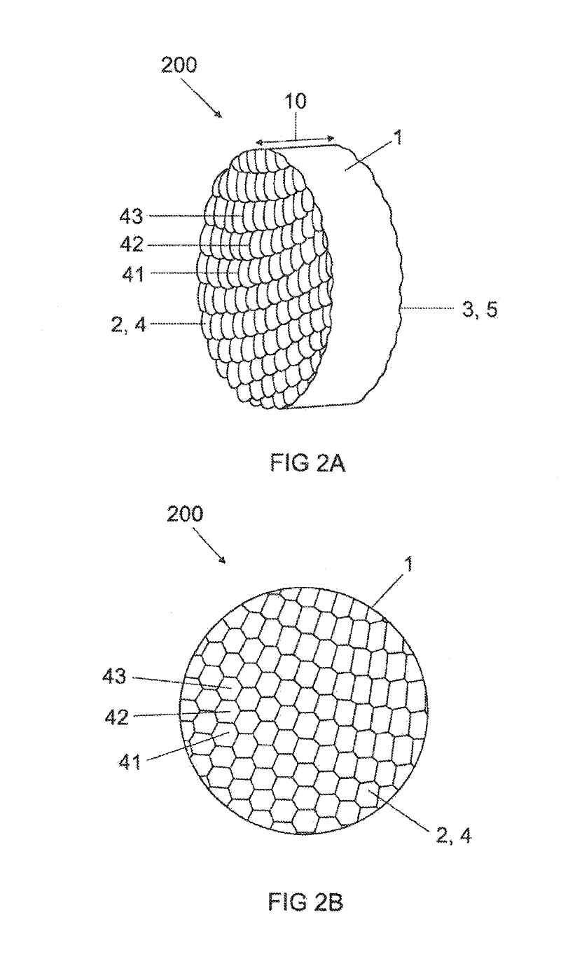

FIGS. 2A and 2B show a further exemplary embodiment of an optical component 200. FIGS. 2A and 2B each show only one detail of the optical component 200, wherein 2A shows a three-dimensional detail of the carrier body 1 and 2B shows a top view of a detail of the first main surface 2 having the first lens structure 4.

As in the preceding embodiment, the optical component 200 has a carrier body 1 having a first lens structure 4 on the first main surface 2 and a second enlarged lens structure 5, embodied as mirror-inverted thereto, on the second main surface 3. The first and second lens structures 4, 5 each have a plurality of lens elements, of which the lens elements 41, 42, and 43 of the first lens structure are designated as examples. The lens elements all have a polygonal shape in the form of non-congruent hexagons, which are directly adjacent to one another and adjoin one another. Therefore, the entire first and second main surfaces 2, 3 of the optical component 200 can be covered with lens elements, which all contribute to the optical imaging.

As in the preceding embodiment, the lens elements have a vortex structure in the relative arrangement of the lens elements to one another and a shrinking of the respective area of the lens elements proportionally to the distance to the center point (not shown) of the first main surface 2 of the carrier plate 1.

The optical component 200 may have, for example, a circular shape having a diameter of greater than or equal to 1 cm and less than or equal to several tens of centimeters. The thickness 10 of the carrier plate 1 can be greater than or equal to 100 μm and less than or equal to several millimeters depending on the desired focusing or defocusing properties. For example, a carrier body having a diameter of approximately 10 cm and a thickness of approximately 2 mm is advantageous for illuminating devices. The mean diameter of a lens element is approximately 1 mm at a focal length of the lens elements of approximately 2 mm, so that the first or second lens structure 4, 5 respectively has approximately 10,000 lens elements.

Alternatively thereto, the thickness 10 of the carrier plate 1 can also be approximately 500 μm and the lens elements can have a focal length of approximately 500 μm, for example. Thicknesses of several millimeters and lens sizes of less than 1 mm are typical. The thickness results from the focal length or vice versa.

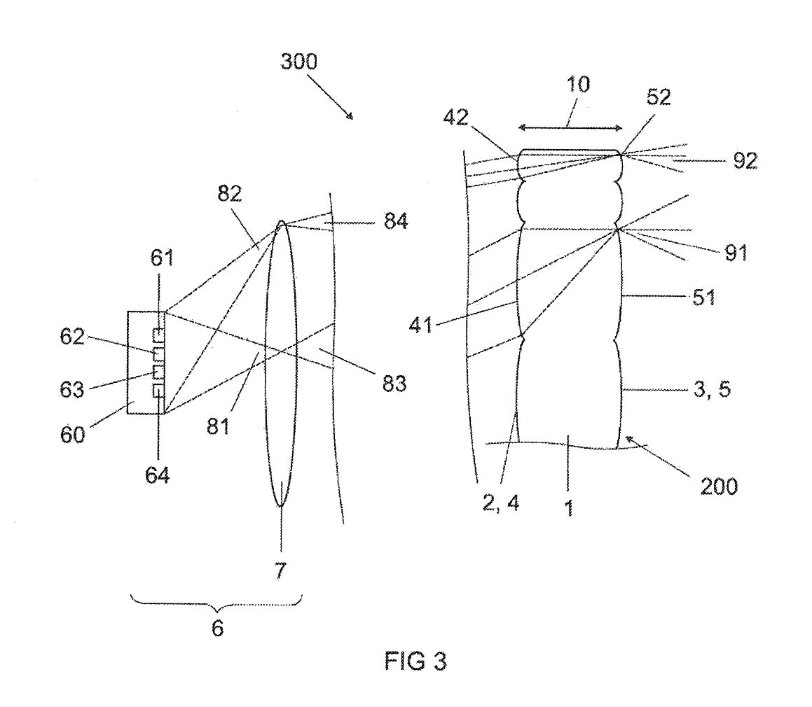

FIG. 3 shows an exemplary embodiment of an illuminating device 300. The illuminating device 300 includes a light source 6, which has four LEDs 61, 62, 63, 64 on a carrier 60 in the embodiment shown. The LED 61 emits red light in operation, the LEDs 62 and 63 emit green light, and the LED 64 emits blue light. Since the LEDs 61 to 64 are arranged adjacent to one another on the carrier 60 in the emission direction, the light emitted from the carrier 6 having the LEDs 61 to 64 has an inhomogeneous luminance and color distribution.

Furthermore, the light source 6 includes a collimator 7, which is arranged downstream from the LEDs 61 to 64 in the emission direction and collimates the light emitted by the LEDs 61 to 64 in a limited spatial angle range. An optical component 200 as shown in the preceding embodiment is arranged downstream from the collimator 7, of which only a detail is shown in 3. In particular, the light source 6 having the LEDs 61 to 64 and the collimator 7 and the optical component 200 are arranged along a shared optical axis (not shown).

The collimator 7 is embodied in the embodiment shown as a lens. It can be a Fresnel lens, for example. However, the light emitted from the collimator 7 has an inhomogeneous luminance and color distribution, like the light emitted directly from the carrier 60 having the LEDs 61 to 64.

As indicated by the dashed lines between the carrier 60 and the collimator 7, the LEDs 61 to 64 appear, viewed from the collimator 7, to be at a maximum angle 83 from the center of the collimator, while they appear to be at a minimum angle 82 viewed from the edge of the collimator 7. Because of the maintenance of etendue in classical imaging systems, the light of the LEDs 61 to 64 is bundled more strongly at the edge of the collimator 7 than in the center of the collimator 7. At the edge of the collimator, the light is emitted at a minimum aperture angle 84, while the light in the center of the collimator 7 is emitted at a maximum angle 83. Such an oriented emission in a limited spatial angle range can be desirable in particular for illuminating applications.

The emission characteristic of the light source 6 can be described by an emission cone having an aperture angle, which corresponds, for example, to the aperture angle in which the light intensity emitted along the optical axis has dropped by half. The aperture angle, which therefore defines the limited spatial angle range in which the light source emits collimated light, can be set, for example, by the distance between the collimator 7 and the LEDs 61 to 64.

Because of the above-described emission characteristic of the collimator 7 having the aperture angles of the light emitted from the collimator 7, which becomes smaller toward the outside, it follows for the lens elements of the first and second lens structures 4, 5 of the optical component 200, as described in conjunction with the preceding embodiment, that the areas of the lens elements which are arranged farther away from the center point of the carrier plate 1 are embodied as smaller than the areas of the lens elements which are arranged closer to the center point of the carrier plate 1. However, this is not absolutely necessary.

The first main surface 2 having the first lens structure 4 forms a radiation entry surface of the optical component 200 for the light emitted from the light source 6, while the second main surface 3 having the second lens structure 5 forms a radiation exit surface.

As is obvious from FIG. 3, the thickness 10 of the carrier plate 1 and the focal length of the lens elements of the first lens structure 4 can be selected such that light beams of each lens element of the first lens structure 4, which are incident from the light source 6 on the optical component 200 are imaged on the lens element of the second lens structure 5 located behind it, i.e., on the radiation exit surface.

The emission angle at which the light is then emitted from the radiation exit surface, i.e., the lens elements of the second lens structure 5, behaves similarly to the emission angle of the collimator 7, as shown as an example by the angles 91 and 92. Because of the emission characteristic of the light source 6 and the arrangement of the lens elements of the first and second lens structures 4, 5, the light is emitted more strongly in the forward direction from the lens elements located at a greater distance from the center point of the carrier plate 1, i.e., at a smaller aperture angle, than from lens elements which are arranged closer to the center point of the carrier plate 1.

The optical component 300 shown here is also distinguished by very good mixing of the light emitted from the light source 6. The first and second lens structures 4, 5 shown here allow a high spatial resolution of the lens elements, which in turn causes inhomogeneous brightness and/or color distributions to be imaged on the first lens structure 4, which forms the radiation entry surface, by the plurality of the lens elements on the radiation exit surface or second lens structure 5 and to be superimposed by the second lens structure 5 in the far field. The superposition is composed of all images of the light source 6, which are generated by each individual lens element on or behind the second lens structure 5 forming the radiation exit surface.

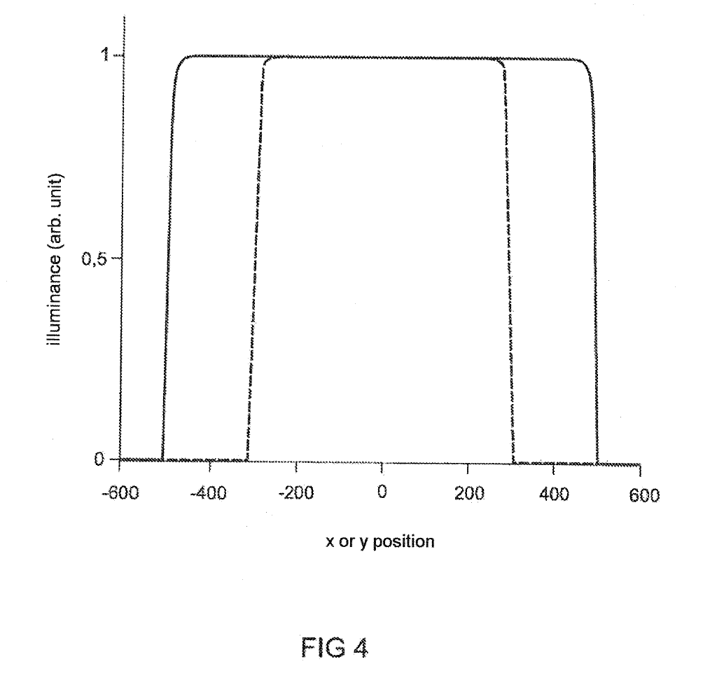

FIG. 4 shows the illuminance distribution in the two directions x and y as a function of the distance for an optical component according to the prior art as described in WO 2009/065389. A sharp drop is shown both in the x direction and also in the y direction.

FIG. 5 shows the definition of the terms used here for a concrete polygonal lenslet 20, wherein the entire area of the main surface is paved with such lenslets 20. The center point and origin are designated with M and U. The distance of the center points M in the x direction is dx and the distance of the center points M in the y direction is dy.

FIGS. 6A and 6B show, solely schematically, a superposition of the two main surfaces H1 and H2 in order to demonstrate the principle of distortion. The first main surface H1 is shown using solid lines, the second main surface H2 is shown using dashed lines. The enlargement factor a is selected as of equal size in both directions x and y here, originating from the origin U. This factor a is given by x2:x1 and similarly by y2:y1.

FIG. 7 shows an illustration of the respective homogenized light distribution achievable using different factors a. The y position of the illuminance in arbitrary units (arb. unit) is shown on top and the x position is shown on the bottom. Surprisingly, it has been shown that a small factor of the enlargement or distortion a of 0.1 to 0.5% is already sufficient to optimize the blurriness. In other words, a is of equal size here in the x and y directions and the following applies: 1.001≦a≦1.005. The curve 1 is related to a=1.0. For curve 2, a=1.002 applies, for curve 3, a=1.005, for curve 4, a=1.001.

While the disclosed embodiments has been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An optical component having comprising:
a carrier plate comprising a first main surface and a second main surface facing away from the first main surface,
a given lens structure in the form of a microlens array on the first main surface, wherein the first lens structure covers the first main surface, and
a lens structure in the form of a microlens array on the second main surface, wherein the lens structure of the second main surface is similar to that of the first in the meaning of a projection, wherein the projection is distorted by a factor a in relation to an origin, which is located at an arbitrary point of the main surfaces, wherein the distortion factor a is at least a=1.001, wherein the distortion is active in at least one direction.

2. The optical component as claimed in claim 1, wherein the distortion is identical in all directions of the main surface.

3. The optical component as claimed in claim 1, wherein the distortion has two axes of symmetry.

4. The optical component as claimed in claim 3, wherein the distortion has two axes of symmetry perpendicular to one another.

5. The optical component as claimed in claim 1, wherein the distortion factor a is at most 1.05.

6. The optical component as claimed in claim 5, wherein the distortion factor a is at most 1%, i.e., a=1.01.

7. The optical component as claimed in claim 3, wherein the distortion factor differs in various directions by at most 30%.

8. The optical component as claimed in claim 3, wherein the distortion factor is of equal size in both directions.

9. The optical component as claimed in claim 1, wherein the distortion factor changes as a function of the distance from an origin.

10. The optical component as claimed in claim 1, wherein the lens structure has a polygonal shape, rectangle, rhomboid, trapezoid, or honeycomb, wherein complete paving of the main surface is achieved.

11. The optical component as claimed in claim 1, wherein the lens structure comprises multiple different-shaped lens elements.

12. An illuminating device comprising:
at least two different-colored light sources and having an optical component, which is seated in the beam path of the light sources, the optical component comprising a carrier plate comprising a first main surface and a second main surface facing away from the first main surface,
a given lens structure in the form of a microlens array on the first main surface, wherein the first lens structure covers the first main surface, and
a lens structure in the form of a microlens array on the second main surface, wherein the lens structure of the second main surface is similar to that of the first in the meaning of a projection, wherein the projection is distorted by a factor a in relation to an origin, which is located at an arbitrary point of the main surfaces, wherein the distortion factor a is at least a=1.001, wherein the distortion is active in at least one direction.

13. The illuminating device claimed in claim 12, wherein the light sources emit light in a limited spatial angle in operation, wherein the optical component is seated in the beam path of the light sources, and wherein the light sources have an arrangement having light-emitting semiconductor components and a collimator arranged downstream from the arrangement.
